(19) United States
(12) Patent Application Publication
(10) Pub. No.: US 2013/0190953 A1
(43) Pub. Date: Jul. 25, 2013

(54) METHOD FOR INCREASING THE AVAILABILITY OF HYBRID VEHICLES

(71) Applicants: Holger Niemann, Shanghai (CN); Andreas Heyl, Ludwigsburg (DE)

(72) Inventors: Holger Niemann, Shanghai (CN); Andreas Heyl, Ludwigsburg (DE)

(21) Appl. No.: 12/998,351

(22) PCT Filed: Sep. 10, 2009
(86) PCT No.: PCT/EP2009/061730

§ 371 Date: Jun. 20, 2011

(30) Foreign Application Priority Data
Oct. 16, 2008 (DE) 10 2008 042 887.6

(51) Int. Cl. B60W 20/00; B60K 6/442; B60W 10/02; B60W 10/08; B60W 10/06

(52) U.S. Cl. CPC B60W 20/20; B60W 10/08; B60W 10/06; B60W 10/02; B60K 6/442; B60W 2600/00; Y10S 903/93
USPC 701/22; 180/65.23; 180/65.265; 903/930

(57) ABSTRACT

In a method for increasing the availability of a hybrid drive having an internal combustion engine and an electric motor, the electric motor is operated as a starter of the internal combustion engine as well as a travel drive unit within the hybrid drive, and at least one operating parameter, corresponding to an operating parameter of the at least one electric motor, is ascertained. An error is identified if the at least one operating parameter value does not correspond to an operating parameter standard state, in which case the operation of the electric motor as the travel drive unit is at least partially limited. Lastly, a driving state-dependent error response is carried out depending on the instantaneous operating state of the hybrid drive.

### BACKGROUND OF THE INVENTION

1. Field of the Invention

The present invention relates to control mechanisms for operating internal combustion engines and electric motors which are used in combination as hybrid drives.

2. Description of Related Art

The combined use of electric machines and internal combustion engines in a hybrid drive allows greater efficiency in the propulsion of vehicles, as well as flexible adaptation of the drive unit to the intended driving mode. A hybrid drive in particular allows efficient utilization of the internal combustion engine due to the storage of electrical energy which has been obtained via the electric machine as a generator, as well as the recovery, i.e., recuperation, of kinetic energy during deceleration.

On the one hand, in hybrid drives the internal combustion engine as well as the electric machine is used for the drive, and on the other hand, there are hybrid drive designs in which the electric machine is used as a starter for starting the internal combustion engine. An additional electric starter motor and activation thereof may be dispensed with in this way.

Compared to common, conventional internal combustion engine drives, hybrid drives require more complex control due to the fact that an internal combustion engine must be operated together with an electric machine in order to provide the drive and a multistage control for the electric machine, since the latter is used as a travel drive element as well as a starter.

For known hybrid drives in which the electric machine is used as a starter for the internal combustion engine, the operation of the electric machine is monitored, and when errors are recognized the electric machine is limited or shut off for safety reasons. According to the related art, control systems are used to monitor the activation, the regulation, and the sensors of the electric machine as well as the operation of the electric machine itself, and to shut off the electric machine if necessary. The electric machine is usually shut off immediately when an error is recognized.

The three-level principle according to EGAX is used for the monitoring of engine control units. Torque coordination, computation of setpoint and actual torques, and various sensor plausibility routines are carried out in a first level.

Function monitoring is carried out in a second level, via which the correctness, i.e., the proper execution, of the functions in the first level is monitored. The function monitoring which is carried out in the second level includes a torque comparison which allows computing errors in the first level as well as sensor errors occurring there to be identified.

A further, third level includes computer monitoring, via which the proper operation of the involved computer components of the engine control unit are monitored.

Within the scope of this three-level concept, an error response is usually provided in multiple stages. The error is initially “debounced.” After an error is detected, an error response time must be observed, after which the safe state must be adopted. Instead of immediately responding to a detected error, this time may be used to wait for the error, for example a bit carrier caused by EMI, to be autonomously corrected. The waiting time during which the error is autonomously corrected is referred to as “debouncing,” which increases the availability. In a further stage, the control unit is reset (reset signal), the output stages are switched off, and the control unit is reinitialized.

A limited alternative operation of the output stages of the control unit may be carried out in a third stage, while an irreversible shutoff of the system takes place in a fourth stage. The irreversibly shut-off system may be restarted only by turning the ignition off and then back on again. In the event of a continuing error the system remains deactivated, even after an ignition signal is transmitted.

For hybrid drive systems in which multiple control units are used, for example a primary motor having a primary motor control unit and a secondary motor control unit, the above-described three-level concept is likewise implemented in each individual control unit. The error response may be different for each control unit; for example, the fourth stage may be involved, i.e., causing the secondary motor to be immediately shut off after prior debouncing of the error.

For a hybrid vehicle in which the secondary motor is used, for example, for the electric drive and also as a starter-generator of the primary motor for the internal combustion engine, for example, an error in the secondary motor may result in failure of the entire system: When the vehicle is operated solely by the secondary motor at the moment that an error occurs in the control unit of the secondary motor, and the primary motor, i.e., the internal combustion engine, is shut off, the time until the onset of the error response in stage four, for example, which immediately switches off the output stage of the secondary motor, is no longer sufficient to start the primary motor beforehand. In addition, when the vehicle is restarted via an off/on ignition signal, as the result of continuing errors in the control unit of the secondary motor, erroneous self-tests may occur, so that the monitoring system no longer allows the secondary motor to be started. Thus, the primary motor, i.e., the internal combustion engine, which in fact would be operational, also can no longer be started. The vehicle therefore comes to a standstill due to errors in the secondary motor, although the primary motor, i.e., the internal combustion engine, is actually functioning in an error-free manner.

### BRIEF SUMMARY OF THE INVENTION

An object of the present invention is to increase the availability of a hybrid drive.

According to the approach proposed by the present invention, a hybrid drive in a vehicle may also be operated using an electric machine which may possibly no longer be suitable as a drive unit for the driving operation, but which is still suitable as a starter or generator, for example. Using the approach proposed according to the present invention and the method proposed according to the present invention, shut-down vehicles having a hybrid drive, and whose electric machine is no longer usable as a drive but whose internal combustion engine in principle is operational, may be activated. The shutdown of the entire hybrid drive when errors occur in the electric drive, i.e., in the electric machine, is overcome using the approach proposed according to the present invention.

Using the approach proposed according to the present invention, it is now possible to operate the electric machine, which is no longer suitable as a drive component due to the error, in another function, for example as a starter for the internal combustion engine, i.e., the primary motor. Thus, even when the electric drive component is inoperative the hybrid drive may be activated by starting the internal combustion engine using the electric machine which is defective, i.e., unsuitable for the drive.

Using the approach proposed according to the present invention, the error response of the secondary motor, i.e., the electric drive of the hybrid drive, is made a function of the instantaneous situation of the vehicle equipped with the hybrid drive. If this vehicle is in a mode in which it is driven only by the secondary motor, i.e., the electric machine, the error response is adjusted in such a way that it is still possible to start the primary motor, i.e., the internal combustion engine, before the secondary motor, i.e., the electric drive, is shut off.

The safety of the vehicle equipped with the hybrid drive remains ensured by specifying suitable conditions under which this modified error response is still allowed.

To name one example, if a continuing error occurs via control units of the secondary motor, i.e., the electric drive, this results in switching off of the output stages.

Depending on the instantaneous operating state, there are a number of possible responses of the vehicle control system to this error:
1) the vehicle travels in hybrid mode; i.e., a drive is provided by the primary motor (internal combustion engine) as well as by the secondary motor (electric machine).
2) the vehicle travels in generator mode; this means that the primary motor, i.e., the internal combustion engine, charges an energy storage via the secondary machine, i.e., the electric drive, for example an energy storage in the form of a battery or a pressure storage.
3) the vehicle travels solely via the secondary motor, i.e., the electric drive, and the primary motor, i.e., the internal combustion engine, is shut off.

In cases 1) and 2), shutting off the secondary motor, i.e., the electric drive, does not immediately result in a reduction in the availability of the hybrid drive. The vehicle may continue to be driven via the primary motor, which, however, now operates without assistance from the secondary motor. This means that the recuperation and generation operating states are no longer possible. In operating states 1) and 2) the primary motor, i.e., the internal combustion engine, is active, so that no measures are required.

In case 3), i.e., for a vehicle operated solely via the secondary motor and with the internal combustion engine shut off, shutting off the secondary motor by the monitoring function in the event of an error would immediately result in shutdown of the vehicle. Using the approach proposed according to the present invention, it is possible to restart the shut-off primary machine via the secondary drive, thus avoiding shutdown of the vehicle.

In the latter case 3) it is conceivable that the primary motor, i.e., the internal combustion engine, may be started under certain conditions, which may be subjected to plausibility checking, before the secondary motor, i.e., the electric drive, is shut off. For vehicles, i.e., electric vehicles, which include hybrid-driven vehicles, the following safety-relevant rules apply:
A) no unintentional acceleration may occur; no unintentional torque which is greater than a defined fraction of the maximum torque may act on a driven wheel for longer than a defined period of time; and
B) unintentional motion is allowed only in accordance with Regulation ECE R-100, which provides that an electric vehicle may not move from a standstill by more than 10 cm as the result of an error.

In accordance with these two safety-relevant criteria, under the conditions stated below the primary motor, i.e., the internal combustion engine, may be started by the secondary motor, i.e., the electric drive, while ensuring safety when the following conditions are met:

The primary motor is started, and the drive train between the motors, i.e., between the primary motor and the secondary motor, is engaged. This is carried out via a clutch. During the starting procedure, the primary motor must be able to absorb a greater fraction of the difference in torque between the driver input and the maximum torque which, as a function of the operating state, may be instantaneously set by the secondary motor and the primary motor, so that safety criterion A) may be taken into account. In this regard it is important to note that the torque is greatly dependent on the rotational speed. One conceivable safety criterion could be defined, for example, as follows:

$$\frac{( Maximum {torque}_{EM} - Drive train losses )}{( Maximum {torque}_{EM} + Maximum {torque}_{VKM} )} \leq 20 \%$$

The drive train may assist the primary motor in absorbing torque, in that the drive train contributes to ensuring that less than the smaller fraction of the difference in torque arrives at the wheels, which is possible, for example, as the result of a disengaged converter clutch upstream from the transmission, which at low rotational speeds is able to transmit only a small portion of the incoming torque, for example for an electric motor as secondary motor at a lower reduction in rotational speed. Furthermore, to meet safety criterion A) it must be ensured that the torque of the secondary motor undergoes an additional reliable plausibility check in the vehicle master computer, so that an excessive torque at the wheels for an unacceptable time period is prevented at all times.

With regard to safety criterion B), according to which an electric vehicle may not move from a standstill by more than 10 cm as the result of an error, it is a condition that the vehicle speed is not greater than 0 or a threshold. The primary motor, i.e., the internal combustion engine, may be started either after an error debouncing of the secondary motor is completed, or, as a preventative measure, during the debouncing of the error. After a successful starting operation for the primary motor, i.e., the internal combustion engine, the secondary motor is shut off and a shutdown of the vehicle is avoided due to the fact that the primary motor, i.e., the internal combustion engine, is available within the hybrid drive.

### BRIEF DESCRIPTION OF THE DRAWINGS

FIG. 1 shows a diagram of a schematically represented illustration of a hybrid drive in (a) normal operation and (b) in a state in which an identified error is present.

FIG. 2 shows a flow chart of one execution of the method proposed according to the present invention.

### DETAILED DESCRIPTION OF THE INVENTION

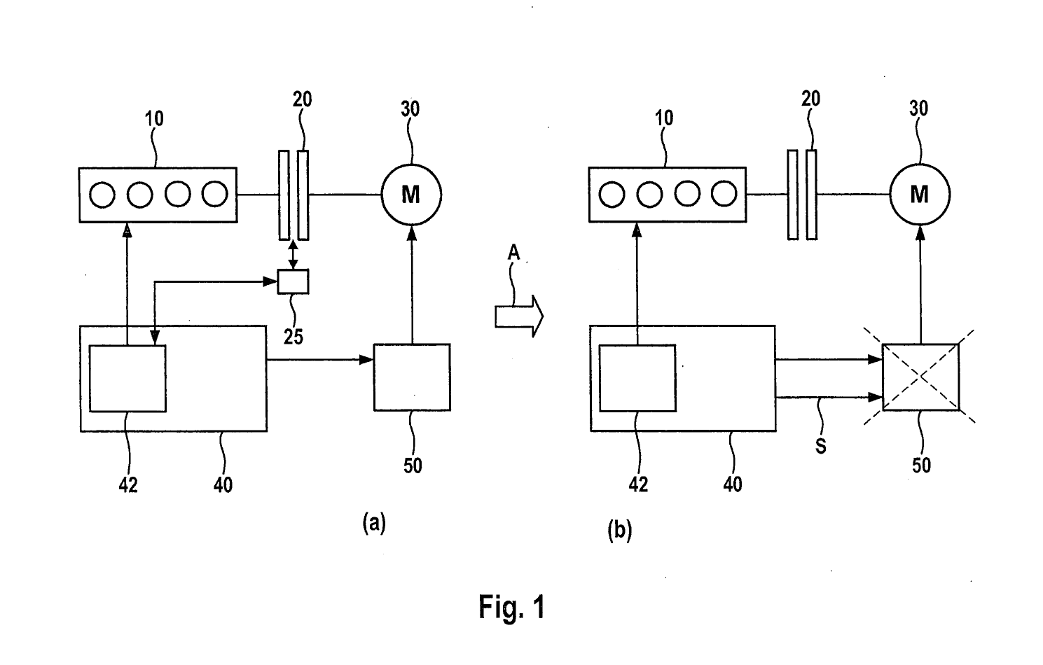

FIG. 1 illustrates a diagram of a control system of a parallel hybrid drive in two states (a) and (b). FIG. 1 shows an internal combustion engine 10, i.e., the primary motor, which is connected to an electric motor 30, i.e., the secondary motor, via a separating clutch 20. Depending on the activation and the clutch state of separating clutch 20, internal combustion engine 10 and/or electric motor 30 transmit(s) mechanical energy to the drive, i.e., a drive train (not illustrated). Otherwise, internal combustion engine 10 transmits rotational energy to electric motor 30 in order to recover electrical energy, which preferably takes place with the drive decoupled, or electric motor 30 transmits mechanical energy in the opposite direction via separating clutch 20, which in this case is engaged, to internal combustion engine 10 in order to start same. As previously explained, the parallel hybrid drive design also provides for the transmission of mechanical energy, i.e., kinetic rotational energy, from electric motor 30 to internal combustion engine 10 in order to assist the drive.

A control unit 40 is connected to internal combustion engine 10, and via an electric motor control unit 50 is connected to electric motor 30. Both connections are used to transmit a torque request, for example in the form of a signal, to internal combustion engine 10 and to electric motor 30, preferably via an appropriate control circuit. Control unit 40 is provided for controlling the entire hybrid drive, and includes an internal combustion engine control unit 42. An electric motor control unit 50 which is external to the hybrid control unit is provided for controlling electric motor 30.

In alternative embodiment variants not illustrated in the drawings, the control components associated with the individual drive motors and also both internal combustion engine control unit 42 and electric motor control unit 50 may be provided within control unit 40 of the hybrid drive, or both may also be provided outside control unit 40. In addition, one of the two mentioned control units 42, 50 may be accommodated in control unit 40 for the hybrid drive, as illustrated in FIG. 1. Overall control unit 40 may be considered as a dual-function control unit of the control system according to the present invention. In FIG. 1(a), the arrows represent the direction of transmission of the torque request. Likewise, the corresponding arrows in FIG. 1(b) represent the corresponding transmission; the lower arrow between control unit 40 and electric motor control unit 50 transmits a signal for deactivation monitoring. The direction of transmission generally corresponds to the direction of the arrow.

In normal operation illustrated in FIG. 1(a), control unit 40 transmits the torque request to electric motor 30 via electric motor control unit 50. However, if an error occurs in electric motor 30, the error is detected by electric motor control unit 50, which according to the three-level concept would cause electric motor 30 to be completely shut off initially. However, the method proposed according to the present invention and the device proposed according to the present invention allow the blocking of electric motor 30 resulting from the error to be at least temporarily cancelled in order to use this drive, which possibly may no longer be suitable for an extended driving operation, as a starter for the possibly shut-off internal combustion engine 10, i.e., the primary motor.

For this purpose, in the circuit according to FIG. 1, an additional deactivation monitoring signal S is transmitted from control unit 40 to electric motor control unit 50 in order to cancel the blocking, provided by electric motor control unit 50, of the starting operation by electric motor 30, i.e., the secondary motor. The blocking provided by electric motor control unit 50 is thus cancelled, as illustrated by the dashed crossed lines at electric motor control unit 50 in FIG. 1(b).

However, the cancellation of the blocking provided by electric motor control unit 50 is regarded as only temporary, so that the dashed crossed lines do not apply for the entire drive mode of electric motor 30, i.e., the secondary drive. For a control unit for electric motor 30, according to the related art this would not be possible if an error occurred.

Signal S therefore represents an override signal which, however, only temporarily deactivates control unit 50 for electric motor 30 in order to allow at least one brief starter phase of electric motor 30, so that shut-off internal combustion engine 10, i.e., the primary drive, may be started. Signal S may be transmitted via a dedicated control line, or may use a dedicated logical channel which connects control unit 40 to electric motor control unit 50.

In addition, control unit 40, electric motor control unit 50, or both control units 40, 50 may have an output unit, or an input unit and an output unit, which prevent(s) a long-term active state of cancellation signal S (override signal), for example an RC element, a monostable flip-flop, or an appropriate software segment, which runs in control unit 40 or in electric motor control unit 50. Signal S may be a deactivation monitoring signal, for example a deactivation bit. Control unit 40 itself not only controls the blocking of the error response of electric motor control unit 50, but also monitors same. Such monitoring allows the detection of the error rate, and also to distinguish errors of the electric motor which still permit a starting operation from errors which would make operation of the electric motor, also for starting, impossible.

In addition, control unit 40 may be connected to separating clutch 20 and optionally to other clutches to be provided in order to activate same and/or query their clutch status.

The transition from the state illustrated in FIG. 1(a) to the state illustrated in FIG. 1(b) is brought about by an error signal resulting, for example, from an error occurring at the secondary motor, i.e., electric motor 30. Since for the starting operation signal S cancels the monitoring of electric motor control unit 50, a starting operation is also possible when electric motor control unit 50 is defective. The arrow denoted by reference character A designates such a transition which is brought about by an error in electric motor control unit 50. Arrow A may also designate a recognized error in electric motor 30 which prevents the function as a drive but still allows the function of electric motor 30 as a starter of the primary motor, i.e., internal combustion engine 10. In addition, transition A may be brought about by the above-mentioned types of errors, for example sensor errors, evaluation errors, or sensor signal transmission errors.

The errors which trigger transition A are preferably detected by control unit 40 or by a higher-level control system, the component which detects the error preferably controlling or triggering as a result of the temporary disabling of the error response.

The approach proposed according to the present invention improves the availability of a hybrid drive via an error response having a state-dependent design. If a continuing error occurs, for example, in electric motor control unit 50 of electric motor 30, which represents the secondary motor, this generally causes the output stages to be switched off. Depending on the instantaneous operating state, there are a number of possible responses of control units 42 and 50 to these errors. Possible operating states of the vehicle may be as follows:
1) the vehicle travels in hybrid mode, and in this case is driven by both internal combustion engine 10 (primary motor) and electric motor 30 (secondary motor).
2) the vehicle travels in generator mode; this means that the primary motor, internal combustion engine 10, charges the energy storage via electric motor 30, the secondary motor. The energy storage may be a battery or a pressure storage.
3) the vehicle travels solely in electric motor mode, which means that internal combustion engine 10, i.e., the primary motor, is shut off.

In the case of operating states 1) and 2), shutting off electric motor 30, i.e., the secondary motor, due to an error does not immediately result in a reduction in the availability of the hybrid drive. In this case, the vehicle may continue to be driven via running internal combustion engine 10, i.e., the activated primary motor, which, however, now operates without assistance from electric motor 30, i.e., the secondary motor. In these operating states, recuperation and generation are no longer possible when an error occurs in the secondary motor. At the same time, all hybrid functions are prohibited. The driver of the vehicle equipped with the hybrid drive proposed according to the present invention obtains information indicating the need for repairs.

In operating state 3), during a solely electric motor driving operation shutting off the secondary motor by the monitoring function due to an error immediately results in shutdown of the vehicle. In this case, without the approach proposed according to the present invention, starting internal combustion engine 10, i.e., the primary motor, would no longer be possible, so that the vehicle would necessarily remain at a standstill.

For the case of operating state 3), i.e., traveling in solely electric motor mode, using the approach proposed according to the present invention, the shut-off primary motor, i.e., internal combustion engine 10, may still be started under certain circumstances before electric motor 30 is ultimately shut off. For vehicles or electric vehicles which include hybrid vehicles, the following limitations with regard to safety must be taken into account:
A) no unintentional accelerations may occur. This means that no unintentional torque which is greater than a fraction of the maximum torque may act on the wheels for longer than a defined period of time (1 s, for example); and
B) no unintentional motion may occur. This means that in accordance with Regulation ECE R-100, an electric vehicle may not move from a standstill by more than 10 cm as the result of an error.

Taking these criteria A) and B) into account, it may be possible to start the primary motor, i.e., internal combustion engine 10, while ensuring safety. Internal combustion engine 10 is started, and the drive train between the motors, i.e., internal combustion engine 10 used as the primary motor and electric motor 30 which represents the secondary motor, is engaged by engaging a separating clutch. During the starting operation, the primary motor, i.e., internal combustion engine 10, must be able to absorb the majority, i.e., the greater portion, of the difference in torque between the driver input and the maximum torque which, as a function of the operating state, may be instantaneously set by electric motor 30. The primary motor must absorb sufficient torque so that the risk of excessive torque of the secondary motor may be ruled out, even when this would set its maximum possible torque, which for an electric machine is a function of the rotational speed. Thus, criterion A) could be taken into account according to the following relationship:

(Maximum torque_{EM}−losses)<1.12 torque according to driver input,

whereby torque could be absorbed by the primary motor as described above, or also by the drive train.

The drive train may assist the primary motor, i.e., internal combustion engine 10, in the absorption of torque. This may be made possible, for example, by a disengaged converter clutch upstream from the vehicle transmission which at low rotational speed transmits only a small portion of the incoming torque.

By carrying out an additional reliable plausibility check of the torque of the secondary motor, i.e., electric motor 30, in the vehicle master computer, it may be ensured that no excessive torque at the wheels occurs over an unacceptable period of time.

With regard to condition B), the condition must be met that the vehicle speed is not >0, or is above a certain implementable threshold. The primary motor, i.e., the internal combustion engine, may be started either after an error debouncing of the secondary motor is completed, or, as a preventative measure, during the debouncing of the error.

After the primary motor, i.e., internal combustion engine 10, is successfully started, the secondary motor, i.e., electric motor 30, may be shut off, and the vehicle remains mobile even when a drive source of the hybrid drive is defective or has only limited availability. The smaller fraction of the maximum torque may be 10%, 12%, 15%, or even 20%, and the larger fractions accordingly the respective differences up to 100%.

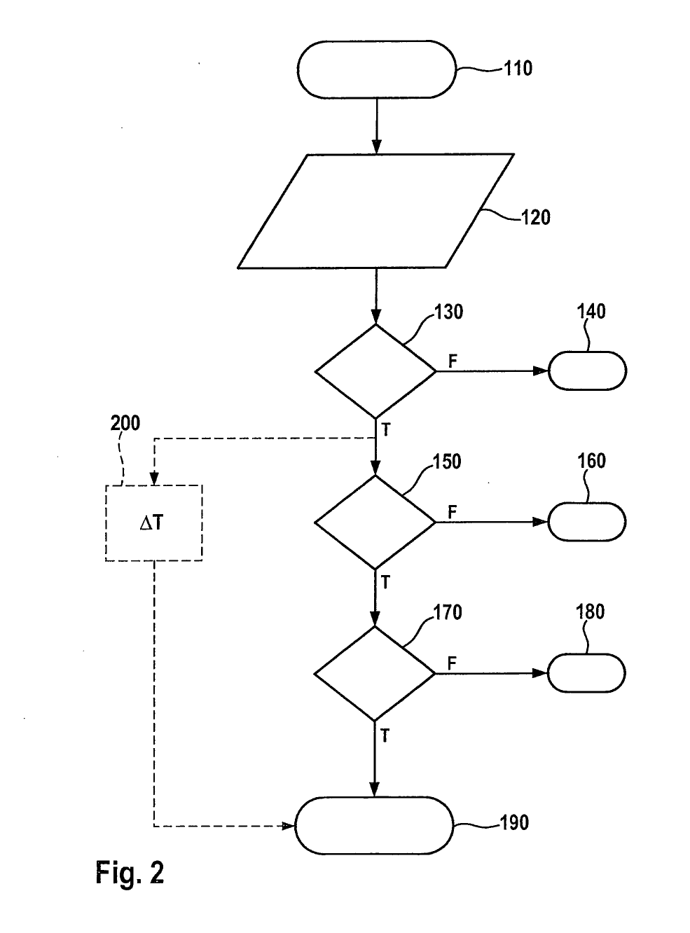

FIG. 2 shows a flow chart which is used as the basis for describing the approach proposed according to the present invention as a whole:

If control unit 40 detects an error T, true, in step 130, electric motor 30, i.e., the secondary motor, is not completely blocked as would be the case for methods according to the related art; instead, further distinctions are made. After an error in branch 130 T is input or ascertained by comparison, a check is made in step 150 as to how serious the error is, and whether electric motor 30 should be completely blocked for safety reasons, or whether only the operation of electric motor 30 as a travel drive unit should be blocked. If it is ascertained in step 150 that the operation as a starter should also be blocked due to the severity of the error (F, false, error does not allow operation as starter), the operation of electric motor 30 is completely blocked in step 160.

On the other hand, if it is ascertained in step 150 that the error allows the operation. of electric motor 30 as a starter (T, true, error allows operation as starter), in step 170 a query is made as to whether the operating mode to be set corresponds to an operation as starter. If this is not the case (F, false, operating mode=operation as travel drive unit), the electric machine is blocked in step 180. Blocking which may have been initiated in step 160 is thus maintained. Step 160 is therefore equivalent to step 180. On the other hand, if it is ascertained in a step 170 that the operating mode to be set corresponds to an operation as starter (T, true), electric motor 30 is operated as a starter in step 190.

In addition, the operation of electric motor 30 as a travel drive unit is preferably blocked in step 190. Such blocking may also be provided in step 130. In this case the blocking is maintained in step 190.

According to the approach proposed according to the present invention, despite a detected error of electric motor 30, operation as a starter is allowed for a limited period of time if this is permitted for the type of error and the operating conditions. The implementation of the time-limited operation is indicated by dashed lines in the flow chart according to FIG. 2. If it is detected in step 130 that an error is present, a predefined period of time ΔT is provided after the error is detected (see step 200), preferably with the aid of a timer. It is ascertained in step 170 that electric motor 30 should be operated as a starter, so that before step 190 (operation as starter) is initiated a query is made as to whether the predetermined period of time is still running. For the sake of clarity, the query is not illustrated in FIG. 2. If step 170 results in T (true), and period of time ΔT has not elapsed, step 190 is carried out. On the other hand, if period of time ΔT has elapsed, electric motor 30 is also blocked for the starter mode (not illustrated in FIG. 2), even if step 170 results in T (true). Step 200 therefore represents an additional prerequisite for running step 190.

1-10. (canceled)

11. A method for increasing the availability of a hybrid drive for a vehicle, the hybrid drive having at least one internal combustion engine which represents a primary motor and at least one electric motor which represents a secondary motor, the at least one electric motor being operated as a starter of the internal combustion engine as well as a travel drive unit within the hybrid drive, comprising:
a) ascertaining at least one operating parameter which corresponds to an operating parameter of the at least one electric motor;
b) identifying an error if the at least one operating parameter value does not correspond to an operating parameter standard state;
c) at least partially limiting the operation of the electric motor as the travel drive unit if an identified error is present; and
d) carrying out a driving state-dependent error response depending on the instantaneous operating state of the hybrid drive.

12. The method as recited in claim 11, wherein in hybrid operating mode of the hybrid drive when the vehicle is driven by the internal combustion engine and the electric motor, and in generator mode of the hybrid drive in which the internal combustion engine charges an energy storage device via the electric motor, the error response according to step d) includes driving the vehicle solely via the internal combustion engine.

13. The method as recited in claim 11, wherein in solely electric motor operating mode of the hybrid drive when the internal combustion engine is shut off, the error response according to step d) includes generating an override signal of the electric motor control unit to allow the starting of the internal combustion engine before the electric motor is shut off.

14. The method as recited in claim 13, wherein the internal combustion engine is started under the following conditions:
i) no unintentional torque greater than a predefined fraction of the maximum torque may act on a driven wheel of the vehicle for no longer than a predefined period of time, thereby preventing unintentional acceleration; and
ii) no unintentional motion of the vehicle from a standstill by more than 10 cm may occur as the result of an error.

15. The method as recited in claim 13, wherein a separating clutch between a drive of the electric motor and a drive of the internal combustion engine is engaged for the absorption of torque during the starting of the internal combustion engine by the electric motor.

16. The method as recited in claim 15, wherein during the starting operation, the internal combustion engine absorbs a predominant portion of the difference in torque between a driver input and a maximum torque which may be instantaneously set by the electric motor as a function of the operating state.

17. The method as recited in claim 16, wherein a drive train of the hybrid drive assists the internal combustion engine in the absorption of torque via a disengaged converter clutch, which at low rotational speeds transmits a small portion of the incoming torque to the wheels to be driven.

18. The method as recited in claim 17, further comprising:
performing a plausibility check of the torque of the electric motor, wherein the plausibility check ensures excessive torque is not present for a predefined period of time at the wheels to be driven.

19. The method as recited in claim 15, wherein the starting of the internal combustion engine is allowed when the absorption of torque is sufficiently great to prevent an endangerment of the electric motor at maximum torque of the drive of the electric motor.

20. The method as recited in claim 18, wherein the electric motor is shut off if the plausibility check of the instantaneously set torque of the electric motor indicates a predefined limit has been exceeded.
